(19) United States
(12) Patent Application Publication
(10) Pub. No.: US 2025/0343236 A1
(43) Pub. Date: Nov. 6, 2025

(54) SINGLE WALL AND DOUBLE WALL CARBON NANOTUBE CONTAINING CATHODES

(71) Applicant: Apple Inc., Cupertino, CA (US)

(72) Inventors: Sung-Jin Kim, Cupertino, CA (US); Na Zhang, Cupertino, CA (US); Hongli Dai, Los Altos, CA (US)

(21) Appl. No.: 19/197,608

(22) Filed: May 2, 2025

Related U.S. Application Data
(60) Provisional application No. 63/641,853, filed on May 2, 2024.

(51) Int. Cl. H01M 4/62; H01M 4/131; H01M 10/0525

(52) U.S. Cl. CPC H01M 4/621; H01M 4/131; H01M 10/0525

(57) ABSTRACT

The disclosure relates generally to batteries, and more particularly, cathodes having a single-wall carbon nanotube (SW-CNT) and/or double-wall carbon nanotube (DW-CNT) binders for use in lithium ion battery cells.

### PRIORITY

This application claims the benefit under 35 U.S.C. § 119 (e) of U.S. Provisional Application Ser. No. 63/641,853, entitled “SINGLE WALL CARBON NANOTUBE-CONTAINING CATHODES,” filed on May 2, 2024, which is incorporated by reference in its entirety herein.

### FIELD

This disclosure relates generally to batteries, and more particularly, cathode active materials having single-wall carbon nanotube (SW-CNT) and/or double wall carbon nanotube (DW-CNT) binders for use in lithium ion battery cells.

### BACKGROUND

Lithium ion (Li-ion) batteries are widely used as the power sources in consumer electronics. There is a need for Li-ion batteries having a high volumetric energy density and that do not include elements that damage the environment such as fluorine atoms.

### SUMMARY

In a first aspect, the disclosure is directed to a cathode comprising a cathode active material and single-wall carbon nanotubes (SW-CNTs) and/or double-wall carbon nanotubes (DW-CNTs). The SW-CNT, DW-CNT, or combination of SW-CNT and DW-CNT containing cathode does not require the presence of a non-CNT binder (e.g., nothing other than SW-CNT and/or DW-CNT binder). In addition, or alternatively, the SW and/or DW-CNT containing cathode does not require the addition of a separate carbon source.

In a second aspect, the disclosure is directed to a cathode comprising a cathode active material and a binder comprising SW-CNTs and/or DW-CNTs. The binder includes no non-CNT binder. In some variations, the cathode active material is 90-99.9 wt % of the cathode. In further variations, the SW-CNTs and/or DW-CNTs are 0.1-10 wt % of the cathode. In further variations, the SW-CNTs have an average diameter of 0.5-2.5 nm. In still further variations, the SW-CNTs have an average length of 50-1000 nm. In some variations, the DW-CNTs have an average length of 10 μm. In still further variations, the DW-CNTs have an average length of 50 μm.

In a third aspect, the cathode includes a conductive carbon. In certain variations, the conductive carbon includes graphite, carbon black, multi-walled CNT, or a combination thereof. In further variations, the cathode includes 0.1-2.0 wt % conductive carbon.

In a fourth aspect, the cathode includes a polar adhesive. In certain variations, the polar adhesive is selected from a polyester/polyurethane, a silanol functionalized adhesive, poly-acrylic acid (PAA), hydrogenated nitrile butadiene rubber (HNBR), and ethylene acrylic rubber (AEM). In still further variations, the polar adhesive is in an amount of 0.02-0.60 wt % of the cathode active material.

In a fifth aspect, the disclosure is directed to a cathode as described herein disposed on a cathode current collector, an anode comprising an anode active material disposed on an anode current collector, wherein the anode oriented towards the cathode such that the anode active material faces the cathode active material; and a separator disposed between the cathode active material and the anode active material. In certain variations, the cathode current collector can be aluminum, copper, nickel, titanium, stainless steel, or an alloy of any one of the foregoing. In still further variations, the cathode current collector is aluminum.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a top-down view of a battery cell, in accordance with an illustrative embodiment;

FIG. 2 is a side view of a set of layers for a battery cell, in accordance with an illustrative embodiment;

FIG. 3A depicts the energy retention at 4.52 V and 25° C. of batteries having SW-CNT-containing cathodes and no non-CNT binder compared to a battery having a MW CNT-containing cathode control, in accordance with an illustrative embodiment;

FIG. 3B depicts the Rss at 4.52 V and 25° C. of batteries having SW-CNT-containing cathodes and no non-CNT binder compared to a battery having a MW CNT-containing cathode control, in accordance with an illustrative embodiment;

FIG. 3C depicts the average voltage respectively at 4.52 V and 25° C. of batteries having SW-CNT-containing cathodes and no non-CNT binder compared to a battery having a MW CNT-containing cathode control, in accordance with an illustrative embodiment.

FIG. 3D depicts the energy retention at 4.52 V and 45° C. of batteries having SW-CNT-containing cathodes and no non-CNT binder compared to a battery having a MW CNT-containing cathode control, in accordance with an illustrative embodiment;

FIG. 3E depicts Rss at 4.52 V and 45° C. of batteries having SW-CNT-containing cathodes and no non-CNT binder compared to a battery having a MW CNT-containing cathode control, in accordance with an illustrative embodiment;

FIG. 3F depicts the average voltage respectively at 4.52 V and 45° C. of batteries having SW-CNT-containing cathodes and no non-CNT binder compared to a battery having a MW CNT-containing cathode control, in accordance with an illustrative embodiment;

FIG. 4A depicts the peal strength of the SW-CNT-containing cathode to the current collector as compared to the MW CNT-containing cathode control, in accordance with an illustrative embodiment;

FIG. 4B depicts the electrode resistivity of the SW-CNT-containing cathode as compared to the MW CNT-containing cathode control, in accordance with an illustrative embodiment;

FIG. 5A depicts the energy retention at 4.52 V and 25° C. of batteries having DW-CNT-containing cathodes and no non-CNT binder compared to a battery having a MW CNT-containing cathode control, in accordance with an illustrative embodiment;

FIG. 5B depicts Rss at 4.52 V and 25° C. of batteries having DW-CNT-containing cathodes and no non-CNT binder compared to a battery having a MW CNT-containing cathode control, in accordance with an illustrative embodiment;

FIG. 5C depicts the average voltage respectively at 4.52 V and 25° C. of batteries having DW-CNT-containing cathodes and no non-CNT binder compared to a battery having a MW CNT-containing cathode control, in accordance with an illustrative embodiment;

FIG. 5D depicts the energy retention at 4.52 V and 45° C. of batteries having DW-CNT-containing cathodes and no non-CNT binder compared to a battery having a MW CNT-containing cathode control, in accordance with an illustrative embodiment;

FIG. 5E depicts the Rss at 4.52 V and 45° C. of batteries having DW-CNT-containing cathodes and no non-CNT binder compared to a battery having a MW CNT-containing cathode control, in accordance with an illustrative embodiment;

FIG. 5F depicts the average voltage at 4.52 V and 45° C. of batteries having DW-CNT-containing cathodes and no non-CNT binder compared to a battery having a MW CNT-containing cathode control, in accordance with an illustrative embodiment;

FIG. 6A depicts the energy retention at 4.52 V and 25° C. of batteries having mixed SW and MW CNT-containing cathodes and no non-CNT binder compared to a battery having a MW CNT-containing cathode control, in accordance with an illustrative embodiment;

FIG. 6B depicts the Rss at 4.52 V and 25° C. of batteries having mixed SW and MW CNT-containing cathodes and no non-CNT binder compared to a battery having a MW CNT-containing cathode control, in accordance with an illustrative embodiment;

FIG. 6C depicts the average voltage at 4.52 V and 25° C. of batteries having mixed SW and MW CNT-containing cathodes and no non-CNT binder compared to a battery having a MW CNT-containing cathode control, in accordance with an illustrative embodiment;

FIG. 6D depicts the energy retention at 4.52 V and 45° C. of batteries having mixed SW and MW CNT-containing cathodes and no non-CNT binder compared to a battery having a MW CNT-containing cathode control, in accordance with an illustrative embodiment;

FIG. 6E depicts the Rss at 4.52 V and 45° C. of batteries having mixed SW and MW CNT-containing cathodes and no non-CNT binder compared to a battery having a MW CNT-containing cathode control, in accordance with an illustrative embodiment; and

FIG. 6F depicts the average voltage at 4.52 V and 45° C. of batteries having mixed SW and MW CNT-containing cathodes and no non-CNT binder compared to a battery having a MW CNT-containing cathode control, in accordance with an illustrative embodiment.

### DETAILED DESCRIPTION

The following description is presented to allow any person skilled in the art to make and use the embodiments, and is provided in the context of a particular application. Various modifications to the disclosed embodiments will be readily apparent to those skilled in the art, and the general principles defined herein may be applied to other embodiments and applications without departing from the spirit and scope of the present disclosure. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims. Thus, the disclosure is not limited to the embodiments shown, but is to be accorded the widest scope consistent with the principles and features disclosed herein.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

As used herein, all cathode active materials are those of as-prepared materials (i.e., “virgin” materials) unless otherwise indicated. Materials of these compositions have not yet been exposed to additional processes, such as de-lithiation and lithiation during, respectively, charging and discharging of a lithium-ion battery.

The disclosure is directed to a cathode including SW-CNTs and/or DW-CNTs as described herein can have a higher volumetric energy density. Further, the cathode includes an environmentally friendly removing fluorine from the SW-CNT and/or DW-CNT containing binder. SW-CNTs and DW-CNTs have higher tensile strength and/or higher thermal conductivity than many other materials, such as PVDF. In some variations, the SW-CNTs and DW-CNTs can have higher conductivity than other materials, such as PVDF.

The SW-CNT-containing cathodes do not require the presence of a non-CNT binder. Likewise, the DW-CNT-containing cathodes do not require the presence of a non-CNT binder. The SW-CNT-containing cathodes when combined with MW CNT-containing cathodes do not require the presence of a binder. Likewise, the DW-CNT-containing cathodes when combined with MW CNT-containing cathodes do not require the presence of a binder. A combination of SW and DW-CNT-containing cathodes do not require the presence of a non-CNT binder. A combination of SW and DW-CNT-containing cathodes when combined with MW CNT-containing cathodes do not require the presence of a non-CNT binder.

The MW CNT-containing alloys require a separate non-CNT binder, or they will not bind components together to form a cathode active material. Accordingly, in various aspects the disclosure is directed to a cathode comprising a cathode active material and SW-CNTs in the absence of non-CNT binder. Likewise, the disclosure is directed to a cathode comprising a cathode active material and DW-CNTs in the absence of non-CNT binder.

The SW-CNT-containing cathode does not require the addition of a separate carbon source. Unlike with a MW CNT, the absence of a separate carbon source provides advantages, including the addition of more cathode active material.

In some alternative variations, the SW-CNT and/or DW-CNT containing cathode can also include a binder such as PVDF. As some options, the SW-CNT and/or DW-CNT containing cathode can also include a separate carbon source.

A battery cell may be formed by electrodes (e.g., anodes and cathodes), one or more separators, electrolyte, a housing, terminals, and other possible componentry. The battery cell may be employed as a source of power for an electronic device. In certain battery cells, such as certain secondary (e.g., rechargeable) battery cells, the electrodes may be stacked and disposed in a housing (e.g., pouch) of the battery cell.

FIG. 1 presents a top-down view of a battery cell 100, in accordance with an embodiment. The battery cell 100 may correspond to a lithium-ion or lithium-polymer battery cell that is used to power a device used in a consumer, medical, aerospace, defense, and/or transportation application. The battery cell 100 includes a stack 102 containing a number of layers that include a cathode, a separator, and an anode. The stack 102 also includes a separator disposed between the cathode and anode. The cathode, anode, and separator layers may be left flat in a planar configuration.

Battery cells can be enclosed, for example in a flexible pouch or a hard case. Returning to FIG. 1, during assembly of the battery cell 100, the stack 102 can be enclosed in a pouch. The pouch can be flexible or rigid. The stack 102 may be in a planar configuration, although other configurations are possible. If flexible, the pouch can be formed by folding a flexible sheet along a fold line 112. For example, the flexible sheet may be made of aluminum with a polymer film, such as polypropylene. After the flexible sheet is folded, the flexible sheet can be sealed, for example, by applying heat along a side seal 110 and along a terrace seal 108. In some variations, the flexible pouch may be less than 200 microns thick to improve the packaging efficiency of the battery cell 100, the density of battery cell 100, or both.

The stack 102 also includes a set of conductive tabs 106 coupled to the cathode and the anode. The conductive tabs 106 may extend through seals in the pouch (for example, formed using sealing tape 104) to provide terminals for the battery cell 100. The conductive tabs 106 may then be used to electrically couple the battery cell 100 with one or more other battery cells to form a battery pack. A battery housing may define a housing interior configured to receive the electrodes. The electrode tab of each electrode may be electrically coupled with a positive battery terminal tab or a negative battery terminal tab, which may extend outside of the housing interior and are configured to be coupled to a load (e.g., an electric device powered by the battery).

Batteries can be combined in a battery pack in any configuration. For example, the battery pack may be formed by coupling the battery cells in a series, parallel, or a series-and-parallel configuration. Such coupled cells may be enclosed in a hard case to complete the battery pack, or may be embedded within an enclosure of a portable electronic device, such as a laptop computer, tablet computer, mobile phone, personal digital assistant (PDA), digital camera, and/or portable media player.

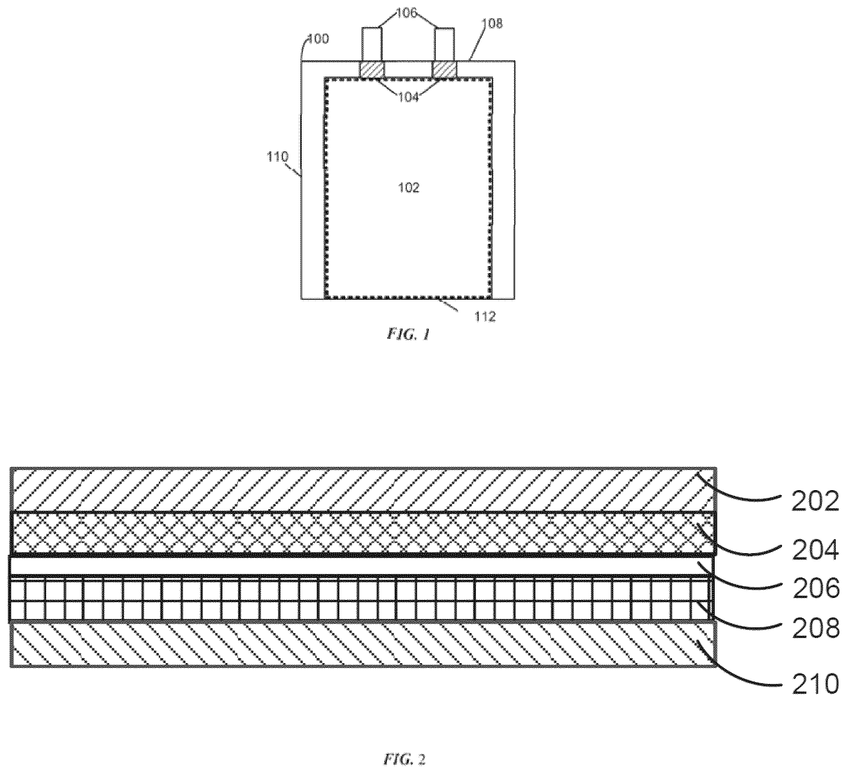

FIG. 2 presents a side view of a set of layers for a first battery cell (e.g., the battery cell 100 of FIG. 1), in accordance with an illustrative embodiment. The set of layers may include a cathode current collector 202, a cathode active material 204, a separator 206, an anode active material 208, and an anode current collector 210. The cathode current collector 202 and the cathode active material 204 form a cathode for the battery cell, and the anode current collector 210 and the anode active material 208 form an anode for the battery cell. To create the battery cell, the set of layers may be stacked in a planar configuration.

Batteries can include binders in cathode active materials to adhere cathode active materials together and adhere the cathode to the current collector. Conventional binders often include PVDF. The binders herein can include SW-CNTs, DW-CNTs, or a combination thereof. As described herein, in various aspects no non-CNT binders are included. In other variations, no binders other than SW-CNTs, DW-CNTs, or a combination thereof can be included. Optionally, the cathode can include additional components including conductive carbon composition and/or a polar adhesive.

The cathode current collector can be formed of any conductive material in the art suitable to form a cathode current collector. In some variations, the cathode current collector can be aluminum, copper, nickel, titanium, stainless steel, or an alloy of any one of the foregoing. In some specific variations, the cathode current collector is aluminum, such as an aluminum foil.

The cathode can include a cathode active material and a binder comprising SW-CNT, DW-CNT, or combination of SW-CNT and DW-CNT. The cathode active material and binder can be in different proportions. In some variations, the cathode includes at least 90 wt % cathode active material. In some variations, the cathode includes at least 92 wt % cathode active material. In some variations, the cathode includes at least 94 wt % cathode active material. In some variations, the cathode includes at least 96 wt % cathode active material. In some variations, the cathode includes at least 97 wt % cathode active material. In some variations, the cathode includes at least 98 wt % cathode active material. In some variations, the cathode includes at least 99 wt % cathode active material. In some variations, the cathode includes at least 99.5 wt % cathode active material. In some variations, the cathode includes less than 100 wt % cathode active material. In some variations, the cathode includes less than or equal to 99.9 wt % cathode active material. In some variations, the cathode includes less than or equal to 99.8 wt % cathode active material. In some variations, the cathode includes less than or equal to 99.5 wt % cathode active material. In some variations, the cathode includes less than or equal to 99.0 wt % cathode active material. In some variations, the cathode includes less than or equal to 98 wt % cathode active material. In some variations, the cathode includes less than or equal to 97 wt % cathode active material. In some variations, the cathode includes less than or equal to 96 wt % cathode active material. In some variations, the cathode includes less than or equal to 94 wt % cathode active material. In some variations, the cathode includes less than or equal to 92 wt % cathode active material. A higher and/or lower weight percent of cathode active material may be chosen, either separately or in any combination, as described herein.

The cathode active material can be any material described in, for example, U.S. patent application Ser. Nos. 14/206,654, 15/458,604, 15/458,612, 15/709,961, 15/710,540, 15/804,186, 16/531,883, 16/529,545, 16/999,307, 16/999,328, or 16/999,265, or PCT US2017/052436 or PCT/US2017/022320, each of which is incorporated herein by reference in its entirety.

The SW-CNTs can have any configuration or combination of conformations known in the art. In some variations, the SW-CNTs have a zig zag configuration. In some variations, the SW-CNTs have an armchair configuration.

The DW-CNTs can have any configuration or combination of conformations known in the art. In some variations, the DW-CNTs have a zig zag configuration. In some variations, the DW-CNTs have an armchair configuration.

In some variations, the cathode includes at least 0.1 wt % of the SW-CNT. In some variations, the cathode includes at least 0.2 wt % of the SW-CNT. In some variations, the cathode includes at least 0.5 wt % of the SW-CNT. In some variations, the cathode includes at least 1.0 wt % of the SW-CNT. In some variations, the cathode includes at least 2.0 wt % of the SW-CNT. In some variations, the cathode includes at least 3.0 wt % of the SW-CNT. In some variations, the cathode includes at least 4.0 wt % of the SW-CNT. In some variations, the cathode includes at least 6.0 wt % of the SW-CNT. In some variations, the cathode includes at least 8.0 wt % of the SW-CNT. In some variations, the cathode includes less than or equal to 10 wt % of the SW-CNT. In some variations, the cathode includes less than or equal to 8 wt % of the SW-CNT. In some variations, the cathode includes less than or equal to 6 wt % of the SW-CNT. In some variations, the cathode includes less than or equal to 4 wt % of the SW-CNT. In some variations, the cathode includes less than or equal to 2 wt % of the SW-CNT. In some variations, the cathode includes less than or equal to 1 wt % of the SW-CNT. In some variations, the cathode includes less than or equal to 0.5 wt % of the SW-CNT.

In some variations, the cathode includes at least 0.1 wt % of the DW-CNT. In some variations, the cathode includes at least 0.2 wt % of the DW-CNT. In some variations, the cathode includes at least 0.5 wt % of the DW-CNT. In some variations, the cathode includes at least 1.0 wt % of the DW-CNT. In some variations, the cathode includes at least 2.0 wt % of the DW-CNT. In some variations, the cathode includes at least 3.0 wt % of the DW-CNT. In some variations, the cathode includes at least 4.0 wt % of the DW-CNT. In some variations, the cathode includes at least 6.0 wt % of the DW-CNT. In some variations, the cathode includes at least 8.0 wt % of the DW-CNT. In some variations, the cathode includes less than or equal to 10 wt % of the DW-CNT. In some variations, the cathode includes less than or equal to 8 wt % of the DW-CNT. In some variations, the cathode includes less than or equal to 6 wt % of the DW-CNT. In some variations, the cathode includes less than or equal to 4 wt % of the DW-CNT. In some variations, the cathode includes less than or equal to 2 wt % of the DW-CNT. In some variations, the cathode includes less than or equal to 1 wt % of the DW-CNT. In some variations, the cathode includes less than or equal to 0.5 wt % of the DW-CNT.

In various aspects, the SW-CNTs can have an average diameter. In some variations, the SW-CNTs have an average diameter. In some variations, the SW-CNTs have an average diameter of at least 0.3 nm. In some variations, the SW-CNTs have an average diameter of at least 0.5 nm. In some variations, the SW-CNTs have an average diameter of at least 0.7 nm. In some variations, the SW-CNTs have an average diameter of at least 1.0 nm. In some variations, the SW-CNTs have an average diameter of at least 1.5 nm. In some variations, the SW-CNTs have an average diameter of at least 2.0 nm. In some variations, the SW-CNTs have an average diameter of at least 2.5 nm. In some variations, the SW-CNTs have an average diameter of at least 3.0 nm. In some variations, the SW-CNTs have an average diameter of at least 3.5 nm.

In some variations, the SW-CNTs have an average diameter of less than or equal to 4.0 nm. In some variations, the SW-CNTs have an average diameter of less than or equal to 3.5 nm. In some variations, the SW-CNTs have an average diameter of less than or equal to 3.0 nm. In some variations, the SW-CNTs have an average diameter of less than or equal to 2.5 nm. In some variations, the SW-CNTs have an average diameter of less than or equal to 2.0 nm. In some variations, the SW-CNTs have an average diameter of less than or equal to 1.5 nm. In some variations, the SW-CNTs have an average diameter of less than or equal to 1.0 nm. In some variations, the SW-CNTs have an average diameter of less than or equal to 0.7 nm. In some variations, the SW-CNTs have an average diameter of less than or equal to 0.5 nm. In some variations, the SW-CNTs have an average diameter of 0.5-2.0 nm.

A higher and/or lower bound of SW-CNT average diameter may be chosen, either separately or in any combination described herein.

In some variations, the SW-CNTs have an average length of at least 50 nm. In some variations, the SW-CNTs have an average length of at least 100 nm. In some variations, the SW-CNTs have an average length of at least 200 nm. In some variations, the SW-CNTs have an average length of at least 400 nm. In some variations, the SW-CNTs have an average length of at least 600 nm. In some variations, the SW-CNTs have an average length of at least 800 nm. In some variations, the SW-CNTs have an average length of at least 1000 nm. In some variations, the SW-CNTs have an average length of at least 2.0 microns. In some variations, the SW-CNTs have an average length of at least 4.0 microns. In some variations, the SW-CNTs have an average length of at least 6.0 microns.

In some variations, the SW-CNTs have an average length of at least 8.0 microns. In some variations, the SW-CNTs have an average length of less than or equal to 10.0 microns. In some variations, the SW-CNTs have an average length of less than or equal to 8.0 microns. In some variations, the SW-CNTs have an average length of less than or equal to 6.0 microns. In some variations, the SW-CNTs have an average length of less than or equal to 4.0 microns. In some variations, the SW-CNTs have an average length of less than or equal to 2.0 microns. In some variations, the SW-CNTs have an average length of less than or equal to 1000 nm. In some variations, the SW-CNTs have an average length of less than or equal to 800 nm. In some variations, the SW-CNTs have an average length of less than or equal to 600 nm. In some variations, the SW-CNTs have an average length of less than or equal to 400 nm. In some variations, the SW-CNTs have an average length of less than or equal to 200 nm. In some variations, the SW-CNTs have an average length of less than or equal to 100 nm. In some variations, the SW-CNTs have an average length of less than or equal to 50 nm.

A higher and/or lower bound of SW-CNT average length may be chosen, either separately or in any combination described herein.

In various aspects, the DW-CNTs can have an average diameter. In some variations, the DW-CNTs have an average diameter. In some variations, the DW-CNTs have an average diameter of at least 3.0 nm. In some variations, the DW-CNTs have an average diameter of at least 3.5 nm. In some variations, the DW-CNTs have an average diameter of at least 4.0 nm. In some variations, the DW-CNTs have an average diameter of at least 4.5 nm. In some variations, the DW-CNTs have an average diameter of at least 5.0 nm. In some variations, the DW-CNTs have an average diameter of at least 5.5 nm. In some variations, the DW-CNTs have an average diameter of at least 6.0 nm. In some variations, the DW-CNTs have an average diameter of at least 6.5 nm. In some variations, the DW-CNTs have an average diameter of at least 7.0 nm. In some variations, the DW-CNTs have an average diameter of at least 7.5 nm.

In some variations, the DW-CNTs have an average diameter of less than or equal to 8.0 nm. In some variations, the DW-CNTs have an average diameter of less than or equal to 7.5 nm. In some variations, the DW-CNTs have an average diameter of less than or equal to 7.0 nm. In some variations, the DW-CNTs have an average diameter of less than or equal to 6.5 nm. In some variations, the DW-CNTs have an average diameter of less than or equal to 6.0 nm. In some variations, the DW-CNTs have an average diameter of less than or equal to 5.5 nm. In some variations, the DW-CNTs have an average diameter of less than or equal to 5.0 nm. In some variations, the DW-CNTs have an average diameter of less than or equal to 4.5 nm. In some variations, the DW-CNTs have an average diameter of less than or equal to 4.0 nm. In some variations, the DW-CNTs have an average diameter of less than or equal to 3.5 nm.

A higher and/or lower bound of DW-CNT average diameter may be chosen, either separately or in any combination described herein.

In some variations, the DW-CNTs have an average length of at least 5 μm. In some variations, the DW-CNTs have an average length of at least 10 μm. In some variations, the DW SW-CNTs have an average length of at least 15 μm. In some variations, the DW-CNTs have an average length of at least 20 μm. In some variations, the DW-CNTs have an average length of at least 25 μm. In some variations, the DW-CNTs have an average length of at least 30 μm. In some variations, the DW-CNTs have an average length of at least 35 μm. In some variations, the DW-CNTs have an average length of at least 40 μm. In some variations, the DW-CNTs have an average length of at least 45 μm.

In some variations, the DW-CNTs have an average length of less than or equal to 50 μm. In some variations, the DW-CNTs have an average length of less than or equal to 45 μm. In some variations, the DW-CNTs have an average length of less than or equal to 40 μm. In some variations, the DW-CNTs have an average length of less than or equal to 35 μm. In some variations, the DW-CNTs have an average length of less than or equal to 30 μm. In some variations, the DW-CNTs have an average length of less than or equal to 25 μm. In some variations, the DW-CNTs have an average length of less than or equal to 20 μm. In some variations, the DW-CNTs have an average length of less than or equal to 15 μm. In some variations, the DW-CNTs have an average length of less than or equal to 10 μm.

A higher and/or lower bound of DW-CNT average length may be chosen, either separately or in any combination described herein.

In some variations, the cathode includes conductive carbon, such as graphite (e.g., a conductive graphite), carbon black (e.g., LitX200), and a combination thereof.

In some variations, the cathode can include no conductive carbon. In some variations, the cathode includes at least 0.1 wt % conductive carbon. In some variations, the cathode includes at least 0.2 wt % conductive carbon. In some variations, the cathode includes at least 0.3 wt % conductive carbon. In some variations, the cathode includes at least 0.4 wt % conductive carbon. In some variations, the cathode includes at least 0.5 wt % conductive carbon. In some variations, the cathode includes at least 0.7 wt % conductive carbon. In some variations, the cathode includes at least 1.0 wt % conductive carbon. In some variations, the cathode includes at least 1.2 wt % conductive carbon. In some variations, the cathode includes at least 1.4 wt % conductive carbon. In some variations, the cathode includes at least 1.6 wt % conductive carbon. In some variations, the cathode includes at least 1.8 wt % conductive carbon.

In some variations, the cathode includes less than or equal to 2.0 wt %. In some variations, the cathode includes less than or equal to 1.8 wt %. In some variations, the cathode includes less than or equal to 1.6 wt %. In some variations, the cathode includes less than or equal to 1.4 wt %. In some variations, the cathode includes less than or equal to 1.2 wt %. In some variations, the cathode includes less than or equal to 1.0 wt %. In some variations, the cathode includes less than or equal to 0.7 wt %. In some variations, the cathode includes less than or equal to 0.5 wt %. In some variations, the cathode includes less than or equal to 0.4 wt %. In some variations, the cathode includes less than or equal to 0.3 wt %. In some variations, the cathode includes less than or equal to 0.2 wt %. In some variations, the cathode includes less than or equal to 0.1 wt %.

In some variations, the cathode includes a polar adhesive. Polar adhesives provide adhesion to the current collector. In some non-limiting variations, the polar adhesive can be selected from a polyester/polyurethane, a carboxylate acid functionalized adhesive, an acetonitrile functionalized adhesive, a silanol functionalized adhesive, PAN, poly-acrylic acid (PAA), hydrogenated nitrile butadiene rubber (HNBR), and ethylene acrylic rubber (AEM).

In some variations, the polar adhesive is in an amount of at least 0.02 wt % of the cathode. In some variations, the polar adhesive is in an amount of at least 0.05 wt % of the cathode. In some variations, the polar adhesive is in an amount of at least 0.10 wt % of the cathode. In some variations, the polar adhesive is in an amount of at least 0.20 wt % of the cathode. In some variations, the polar adhesive is in an amount of at least 0.30 wt % of the cathode. In some variations, the polar adhesive is in an amount of at least 0.40 wt % of the cathode. In some variations, the polar adhesive is in an amount of at least 0.50 wt % of the cathode. In some variations, the polar adhesive is in an amount of less than or equal to 0.60 wt % of the cathode. In some variations, the polar adhesive is in an amount of less than or equal to 0.50 wt % of the cathode. In some variations, the polar adhesive is in an amount of less than or equal to 0.40 wt % of the cathode. In some variations, the polar adhesive is in an amount of less than or equal to 0.30 wt % of the cathode. In some variations, the polar adhesive is in an amount of less than or equal to 0.20 wt % of the cathode. In some variations, the polar adhesive is in an amount of less than or equal to 0.10 wt % of the cathode. In some variations, the polar adhesive is in an amount of less than or equal to 0.05 wt % of the cathode. Any higher and/or lower wt % can be chosen, either separately or in any combination, as described above.

In one example, the cathode includes 98% cathode active material, 1.0% SW-CNT, x % polar adhesive, and (1-x) wt % conductive carbon. In another example, the cathode includes 98% cathode active material, 1.0% DW-CNT, x % polar adhesive, and (1-x) wt % conductive carbon. In another example, the cathode includes 98% cathode active material, 1.0% combination of SW-CNT and DW-CNT, x % polar adhesive, and (1-x) wt % conductive carbon.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

### EXAMPLES

The following examples are for illustrative purposes only. It will be apparent to those skilled in the art that many modifications, both to materials and methods, may be practiced without departing from the scope of the disclosure.

### Example 1

Table 1 depicts the composition of cathodes including SW-CNTs and no non-CNT binder, and a control cathode including MW CNTs and a binder. Specifically, the cathode active materials both include active LCO. The control cathode active material includes an additional carbon, such as graphite (e.g., a conductive graphite), carbon black (e.g., LitX200), and a combination thereof, as well as PVDF binder. The DW-CNT-containing cathode include no non-CNT binder, and as a result was able to able to include more LCO active material.

TABLE 1

| | Active LCO | Carbon 1 | Carbon 2 | Binder |
|---|---|---|---|---|
| Control | 97.6 wt % | 0.9 wt % | 0.45 wt % | 1.05 wt % |
| | | carbon | MWCNT | PVDF |
| | | black | | |
| SW-CNT | 99.0 wt % | | 1.0 wt % | None |
| | | | SWCNT | |

Table 2 depicts a comparison of the specific discharge, first cycle efficiency (FCE), and Rss resistance of the SW-CNT-containing cathode that included no non-CNT binder compared to the control MW CNT-containing cathode, also including an additional carbon source and a binder. The SW-CNT-containing cathodes have values within experimental error of the MW CNT-containing cathodes for each value.

TABLE 2

| | Sp discharge capacity | | | | |
|---|---|---|---|---|---|
| | (mAh/g) | | FCE (%) | Rss | |
| | 25° C. | 45° C. | 25° C. | 25° C. | 45° C. |
| Control | 192.6 ± | 194.8 ± | 92.3 ± | 57.0 ± | 27.9 ± |
| | 2.1 | 1.4 | 0.4 | 3.4 | 1.0 |
| SW-CNT | 192.2 ± | 193.3 ± | 91.6 ± | 60.2 ± | 33.0 ± |
| | 1.9 | 1.3 | 0.4 | 1.7 | 3.8 |

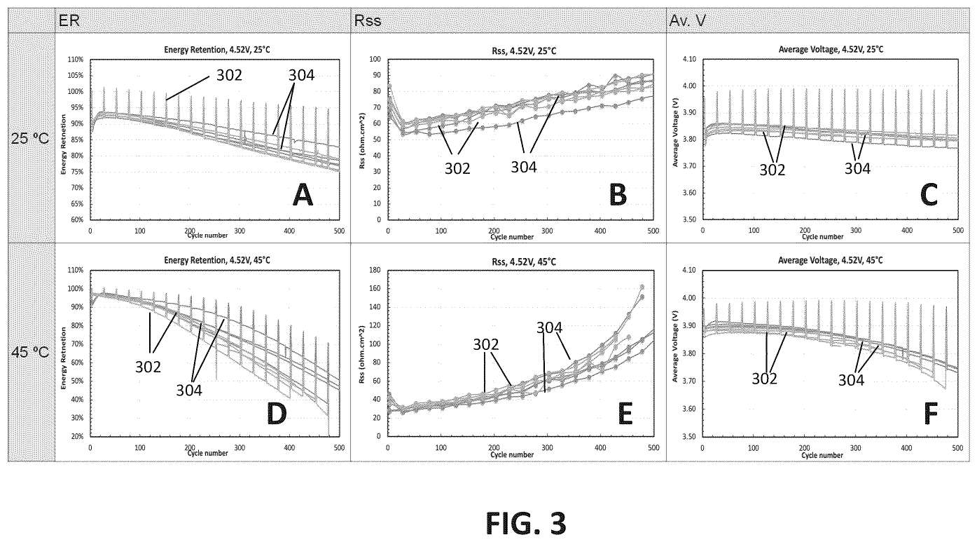

FIGS. 3A-3C depict the energy retention, Rss, and average voltage respectively, each at 4.52 V and 25° C. of batteries having SW-CNT-containing cathodes and no non-CNT binder compared to a battery having a MW CNT-containing cathode control. In FIG. 3A, the energy retention was slightly, but not substantially, lower for batteries having SW-CNT-containing cathodes and no non-CNT binder (302) compared to the MW CNT-containing cathodes (304). In FIG. 3B, the Rss as a function of cycle number for batteries having SW-CNT-containing cathodes and no non-CNT binder (302) was not statistically different from batteries having MW CNT-containing cathodes (304). In FIG. 3C, the average voltage as a function of cycle number for batteries having SW-CNT-containing cathodes and no non-CNT binder (302) was also not statistically different from batteries having MW CNT-containing cathodes (304).

FIGS. 3D-3F depict the energy retention, Rss, and average voltage respectively, each at 4.52 V and 45° C. of batteries having SW-CNT-containing cathodes and no non-CNT binder compared to a battery having a MW CNT-containing cathode control. In FIG. 3D, the energy retention was slightly, but not lower for batteries having SW-CNT-containing cathodes and no non-CNT binder (302) as compared to the MW CNT-containing cathodes having a non-CNT binder (304). In FIG. 3E, the Rss as a function of cycle number for batteries having SW-CNT-containing cathodes and no non-CNT binder (302) was not statistically different from batteries having MW CNT-containing cathodes (304). In FIG. 3F, the average voltage as a function of cycle number for batteries having SW-CNT-containing cathodes and no non-CNT binder (302) was slightly lower than in batteries having MW CNT-containing cathodes (304).

### Example 2

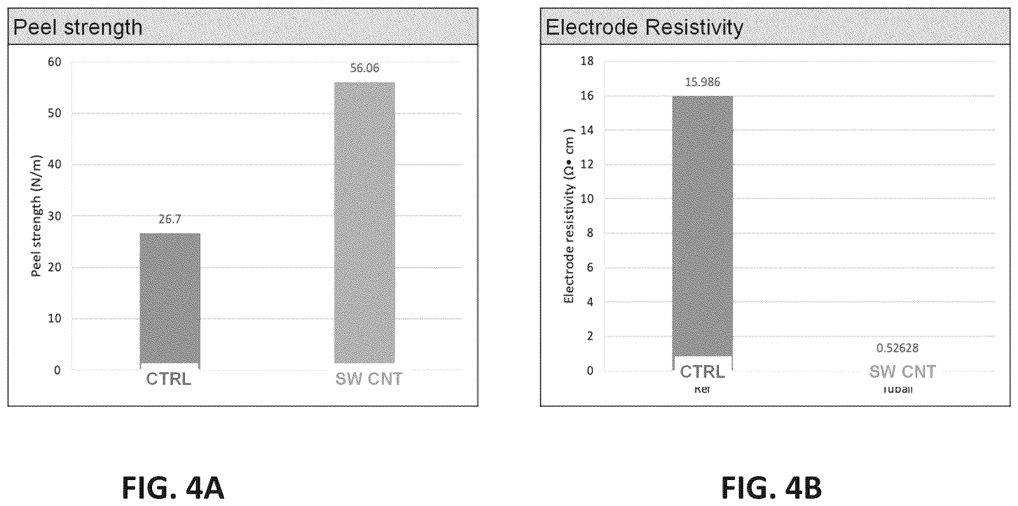

FIG. 4A depicts the peal strength of the SW-CNT-containing cathode to the current collector as compared to the MW CNT-containing cathode control. The peel strength refers to the strength of bonding between the cathode active material and the current collector. The SW-CNT-containing cathode has a substantially higher peel strength than the MW CNT-containing cathode control.

FIG. 4B depicts the electrode resistivity of the SW-CNT-containing cathode as compared to the MW CNT-containing cathode control. The SW-CNT-containing cathode has a substantially lower electrode resistivity.

### Example 3

Table 3 depicts the composition of cathodes including DW-CNTs and no non-CNT binder, and a control cathode including MW CNTs and a binder. Specifically, the cathode active materials both include active LCO. The control cathode active material includes an additional carbon black as well as PVDF binder. The DW-CNT-containing cathode include no non-CNT binder, and as a result was able to able to include more LCO active material.

TABLE 3

| | Active LCO | Carbon 1 | Carbon 2 | Binder |
|---|---|---|---|---|
| Control | 97.6 wt % | 0.9 wt % | 0.45 wt % | 1.05 wt % |
| | | carbon | MWCNT | PVDF |
| | | black | | |
| DW-CNT | 99.0 wt % | | 1.0 wt % | None |
| | | | DWCNT | |

Table 4 depicts a comparison of the specific discharge, first cycle efficiency (FCE), and Rss resistance of the DW-CNT-containing cathode that included no non-CNT binder compared to the control MW CNT-containing cathode, also including an additional carbon source (carbon black) and a binder. The DW-CNT-containing cathodes have values within experimental error of the MW CNT-containing cathodes for each value.

TABLE 4

| | Sp discharge capacity | | | | |
|---|---|---|---|---|---|
| | (mAh/g) | | FCE (%) | Rss | |
| | 25° C. | 45° C. | 25° C. | 25° C. | 45° C. |
| Control | 192.6 ± | 194.8 ± | 92.3 ± | 57.0 ± | 27.9 ± |
| | 2.1 | 1.4 | 0.4 | 3.4 | 1.0 |
| DW-CNT | 191.8 ± | 192.3 ± | 91.9 ± | 54.3 ± | 26.6 ± |
| | 0.5 | 4.2 | 0.7 | 3.6 | 2.7 |

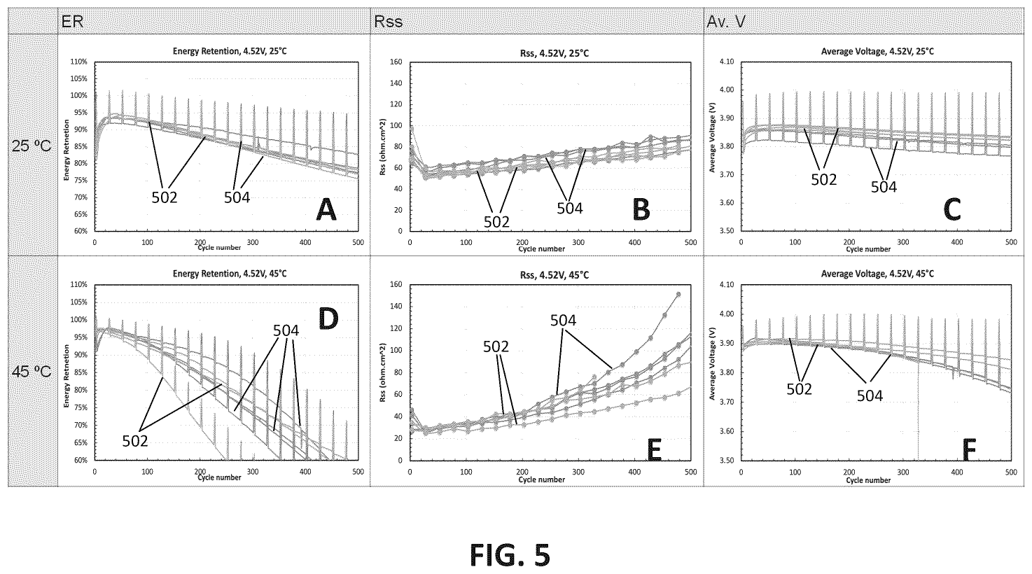

FIGS. 5A-5C depict the energy retention, Rss, and average voltage respectively, each at 4.52 V and 25° C. of batteries having DW-CNT-containing cathodes and no non-CNT binder compared to a battery having a MW CNT-containing cathode control. In FIG. 5A, the energy retention was slightly, but not substantially, lower for batteries having DW-CNT-containing cathodes and no non-CNT binder (502) compared to the MW CNT-containing cathodes (504). In FIG. 5B, the Rss as a function of cycle number for batteries having DW-CNT-containing cathodes and no non-CNT binder (502) was slightly lower for batteries having MW CNT-containing cathodes (504). In FIG. 5C, the average voltage as a function of cycle number for batteries having DW-CNT-containing cathodes and no non-CNT binder (502) was slightly higher than for batteries having MW CNT-containing cathodes (504).

FIGS. 5D-5F depict the energy retention, Rss, and average voltage respectively, each at 4.52 V and 45° C. of batteries having DW-CNT-containing cathodes and no non-CNT binder compared to a battery having a MW CNT-containing cathode control. In FIG. 5D, the energy retention varied from sample to sample without a recognizable improvement or decrease in batteries having DW-CNT-containing cathodes and no non-CNT binder (502) as compared to the MW CNT-containing cathodes having binder (504). In FIG. 5E, the Rss as a function of cycle number for batteries having DW-CNT-containing cathodes and no non-CNT binder (502) was slightly lower in batteries having MW CNT-containing cathodes (504). In FIG. 5F, the average voltage as a function of cycle number for batteries having DW-CNT-containing cathodes and no non-CNT binder (502) was slightly higher than in batteries having MW CNT-containing cathodes (504).

### Example 3

Table 5 depicts the composition of cathodes including SW-CNTs, MW CNTs, and no non-CNT binder, and a control cathode including MW CNTs and a binder. Specifically, the cathode active materials both include active LCO. The control cathode active material includes an additional carbon source (carbon black) as well as PVDF binder. The SW-CNTs and MW CNTs-containing cathode include no non-CNT binder, and as a result was able to able to include more LCO active material.

TABLE 5

| | Active LCO | Carbon 1 | Carbon 2 | Binder |
|---|---|---|---|---|
| Control | 97.6 wt % | 0.9 wt % | 0.45 wt % | 1.05 wt % |
| | | carbon | | |
| | | black | MWCNT | PVDF |
| S/M::1:1 | 99.0 wt % | 0.5 wt % | 0.5 wt % | None |
| | | MWCNT | SWCNT | |

Table 6 depicts a comparison of the specific discharge, first cycle efficiency (FCE), and Rss resistance of the SW-CNTs and MW CNTs-containing cathode that included no non-CNT binder compared to the control MW CNT-containing cathode, also including an additional non-CNT carbon source (carbon black) and a binder. The SW-CNTs and MW CNTs-containing cathodes have values within experimental error of the MW CNT-containing cathodes for each value. The combined SW-CNTs and MW CNTs-containing cathode had a lower peal strength than the control containing only MW CNTs.

TABLE 6

| | Sp discharge capacity | | FCE | | | Peel |
|---|---|---|---|---|---|---|
| | (mAh/g) | | (%) | Rss | | Strength |
| | 25° C. | 45° C. | 25° C. | 25° C. | 45° C. | (N/m) |
| Control | 192.6 ± | 194.8 ± | 92.3 ± | 57.0 ± | 27.9 ± | 26.7 |
| | 2.1 | 1.4 | 0.4 | 3.4 | 1.0 | |
| S/M::1:1 | 191.8 ± | 192.3 ± | 91.9 ± | 54.3 ± | 26.6 ± | 6.4 |
| | 0.5 | 4.2 | 0.7 | 3.6 | 2.7 | |

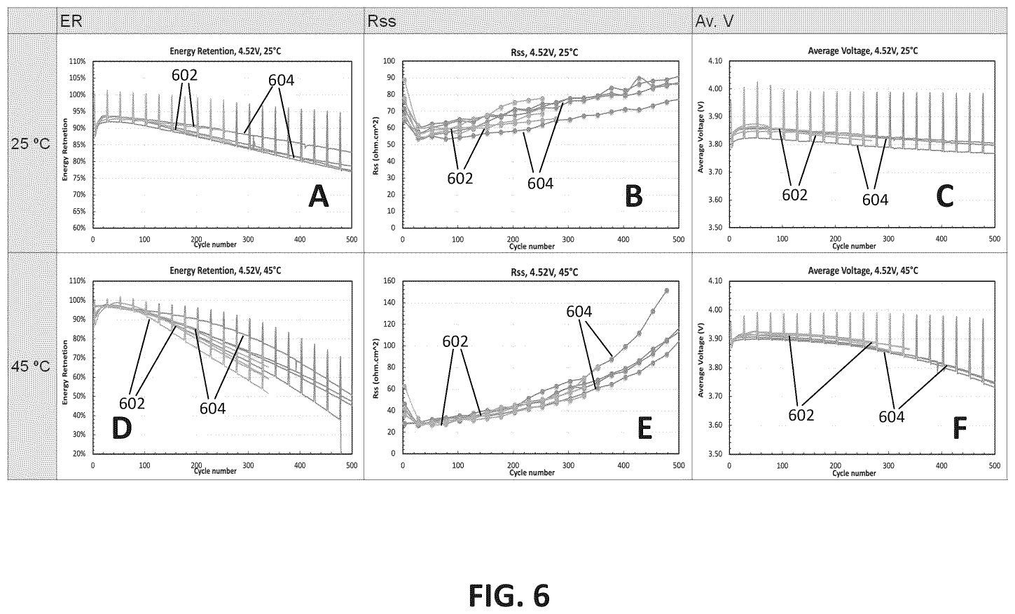

FIGS. 6A-6C depict the energy retention, Rss, and average voltage respectively, each at 4.52 V and 25° C. of batteries having mixed SW and MW CNT-containing cathodes and no non-CNT binder compared to a battery having a MW CNT-containing cathode control. In FIG. 6A, the energy retention not statistically significant for batteries having mixed SW and MW CNT-containing cathodes and no non-CNT binder (602) as compared to the MW CNT-containing cathodes (604). In FIG. 6B, the Rss as a function of cycle number for batteries having mixed SW and MW CNT-containing cathodes and no non-CNT binder (602) was also not statistically significant for batteries having MW CNT-containing cathodes (604). Likewise, in FIG. 6C, the average voltage as a function of cycle number for batteries having mixed SW and MW CNT-containing cathodes and no non-CNT binder (602) was not statistically significant from batteries having MW CNT-containing cathodes (604).

FIGS. 6D-6F depict the energy retention, Rss, and average voltage respectively, each at 4.52 V and 45° C. of batteries having mixed SW and MW CNT-containing cathodes and no non-CNT binder compared to a battery having a MW CNT-containing cathode control. In FIG. 6D, the energy retention was slightly lower in batteries having mixed SW and MW CNT-containing cathodes and no non-CNT binder (602) as compared to the MW CNT-containing cathodes having binder (604). In FIG. 6E, the Rss as a function of cycle number for batteries having mixed SW and MW CNT-containing cathodes and no non-CNT binder (602) was not statistically significant than in MW CNT-containing cathodes (604). In FIG. 6F, the average voltage as a function of cycle number for batteries having mixed SW and MW CNT-containing cathodes and no non-CNT binder (602) was slightly higher than in batteries having MW CNT-containing cathodes (604).

Having described several embodiments, it will be recognized by those skilled in the art that various modifications, alternative constructions, and equivalents may be used without departing from the spirit of the disclosure. Additionally, a number of well-known processes and elements have not been described in order to avoid unnecessarily obscuring the embodiments disclosed herein. Accordingly, the above description should not be taken as limiting the scope of the document.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the method and system, which, as a matter of language, might be said to fall there between.

1. A cathode comprising:
a cathode active material; and
a binder comprising single-wall carbon nanotubes (SW-CNTs), double-wall carbon nanotubes (DW-CNTs), and a combination thereof.

2. The cathode of claim 1, wherein the binder is consisting of SW-CNTs, DW-CNTs, and a combination thereof.

3. The cathode of claim 1, wherein the binder is consisting of SW-CNTs.

4. The cathode of claim 1, wherein the binder is consisting of DW-CNTs.

5. The cathode of claim 1, wherein the cathode comprises multi-wall carbon nanotubes (MW-CNTs).

6. The cathode of claim 1, wherein the cathode active material is 90-99.9 wt % of the cathode.

7. The cathode of claim 1, wherein the SW-CNTs are 0.1-10 wt % of the cathode.

8. The cathode of claim 1, wherein the SW-CNTs have an average diameter of 0.3-4.0 nm.

9. The cathode of claim 1, wherein the SW-CNTs have an average length of 50 nm-10 microns.

10. The cathode of claim 1, further comprising a conductive carbon.

11. The cathode of claim 10, wherein the conductive carbon comprises graphite, carbon black, or a combination thereof.

12. The cathode of claim 10, wherein the cathode comprises 0.1-2.0 wt % conductive carbon.

13. The cathode of claim 1, further comprising a polar adhesive.

14. The cathode of claim 13, wherein the polar adhesive is selected from a polyester/polyurethane, a silanol functionalized adhesive, poly-acrylic acid (PAA), hydrogenated nitrile butadiene rubber (HNBR), and ethylene acrylic rubber (AEM).

15. The cathode of claim 13, wherein the polar adhesive is in an amount of 0.02-0.60 wt % of the cathode.

16. A battery cell comprising:
a cathode according to claim 1 disposed on a cathode current collector;
an anode comprising an anode active material disposed on an anode current collector, the anode oriented towards the cathode such that the anode active material faces the cathode active material; and
a separator disposed between the cathode active material and the anode active material.

17. The cathode of claim 1, wherein the binder is consisting of SW-CNTs, DW-CNTs, and a combination thereof.

18. The cathode of claim 1, wherein the binder is consisting of SW-CNTs.

19. The cathode of claim 1, wherein the binder is consisting of DW-CNTs.

20. The battery cell of claim 16, further comprising a polar adhesive.
